(19) United States
(12) Patent Application Publication
(10) Pub. No.: US 2006/0130116 A1
(43) Pub. Date: Jun. 15, 2006

(54) Time shifting recording switch when phone calling

(76) Inventors: Jun Shi, Shanghai (CN); Jingwei Tan, Shanghai (CN); Liang Gan, Shanghai (CN)

Correspondence Address: Philips Electronics North America Corporation;Corporate Patent Counsel, P O Box 3001, Briarcliff Manor, NY, 10210, US

(21) Appl. No.: 10/531,938

(22) PCT Filed: Oct. 20, 2003
(86) PCT No.: PCT/IB03/04683

§ 371 Date: Oct. 13, 2005

(30) Foreign Application Priority Data
Oct. 23, 2002 (CN) 02146908.3

(51) Int. Cl. H04N 7/173; H04N 7/16

(52) U.S. Cl. 725/134; 725/142; 725/89

(57) ABSTRACT

The invention takes the advantage of features such as TiVo Digital Video Recorders (DVRs) or ReplayTV DVRs, which provide continuous recording of broadcasting programs and allow users to replay any missed portions of the program. The invention records the date and time of incoming/outgoing communication events, such as phone calls, as well as the current channel number being viewed. With reference to the recorded date, time and channel number, it allows users to choose between continuing viewing the current program or going back to view the entire program starting from the missed portions due to one or more incoming/outgoing calls.

### BACKGROUND OF THE INVENTION

The invention relates generally to consumer entertainment systems. More particularly, it relates to set top terminals for use with TV systems for recording the time when on-line connection of an incoming or outgoing communication event is established. This allows a user the flexibility of whether to continue viewing the current TV show or to view it from the time the on-line connection was established.

Set top terminals have been widely used in connection with TV systems for providing a variety of features and options to users, such as providing cable TV services, interactive services, etc. In more recent years, the functionality of set top terminals have been further expanded to include services such as managing and tracking live TV shows in response to a communication event, such as a phone call. When a phone rings while a user is watching an interesting TV show, the user has to make a decision of whether to take the call and miss some portions of the TV show, answer the phone but ask the caller to call at a later time, or simply let the phone ring. In the case of an expected, important or urgent call, the user has no choice but to take the call and skip some portions of the TV show. One way to handle an incoming call is to record the TV show with a video recording device, but the user has to always make sure that a blank video tape is present in the recording device and act quickly when the phone rings.

Another way to handle an incoming phone call is to use a system to pause the TV program. The system buffers the TV program while it is paused, permitting a user to replay missed portions of the video programming. Such an example is disclosed in PCT application no. WO 02/03683, applied by Discovery Communications, Inc.

However, the above system suffers from several drawbacks. First, it is difficult to properly buffer the TV program in response to multiple phone calls occurred at different times. For example, upon receiving a phone call, the system buffers the TV program and allows a user to replay the missed portions of the TV program. While the user is watching the missed portions, another call comes along, and so on. In such a situation, the system would need to buffer the TV program each time an incoming call is answered. However, in reality it is impossible. Another drawback of the system is that it lacks the flexibility of allowing the user to continue viewing the current TV program, especially if it is a live sports event.

Therefore, there is a need for an improved system that provides more flexibility to a user in managing TV programs in response to one or more communication events.

### SUMMARY OF THE INVENTION

The present invention provides a solution that gives more flexibility to a user in managing TV programs in response to one or more communication events.

The invention takes the advantage of the features of digital video recorders (DVRs), such as TiVo DVRs or ReplayTV DVRs, which provide continuous recording of broadcasting programs and allow users to replay any missed portions of the program. According to one embodiment of the invention, it detects whether on-line connection of a communication event is established. Upon detecting the on-line connection, it records date and time of the on-line connection and a current channel number being viewed. A user is then allowed to choose between continuing viewing the video program as it is currently being played and viewing the video program from the time on-line connection was established. If the user chooses to view the video program from the time on-line connection was established, the video contents are retrieved from the storage device starting from the recorded date and time selected by the user and are then played. On the other hand, if the user chooses to continue viewing the video program as it is currently being played, the current video program is played.

In the case of multiple communication events occurring at different times, a user is prompted to select desired date and time for playing the video program. The video contents or a channel number associated with the selected date and time are retrieved starting from the date and time selected by the user and are then played.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 shows a functional block diagram illustrating a set top terminal for use with a TV set, according to one embodiment of the invention;

FIG. 2 is a more detailed diagram of the set top terminal according to one embodiment of the invention;

FIG. 3 shows a flow chart diagram illustrating the operation of the set top terminal according to one embodiment of the invention; and

FIG. 4 shows an exemplary table format for organizing the date, time and address information to be stored.

Throughout the drawings, the same reference numerals indicate similar or corresponding features or functions.

### DETAILED DESCRIPTION OF THE PREFERRED EMBODIMENTS

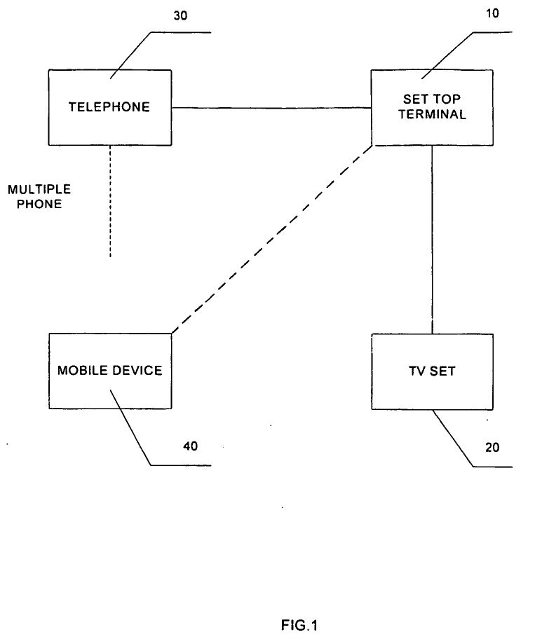

FIG. 1 shows a functional block diagram illustrating a set top terminal 10 for use with a TV set 20, according to one embodiment of the invention. Terminal 10 has a number of features, including performing conventional functions such as receiving and decoding video signals. It also implements digital video recorder (DVR) features such as those provided by TiVo DVRs commercially available from TiVo Inc. in Alviso, Calif., U.S.A, or those provided by ReplayTV DVRs commercially available from SONICblue Inc. in Santa Clara, Calif., U.S.A. A DVR knows the program schedule of all the channels a user receives. Based on the user's instructions, it records programs to an internal hard disk for later playback. The user can pause, rewind, fast-forward or watch in slow-motion any program, live or pre-recorded. Terminal 10 of the invention takes the advantage of these features and records the date and time of incoming/outgoing communication events, such as phone calls from telephone 30 and mobile device 40, as well as the channel number being viewed. With reference to the recorded date, time and channel number, it allows users to have a greater flexibility to choose between continuing viewing the current program or going back to view the entire program starting from the missed portions due to one or more incoming/outgoing calls.

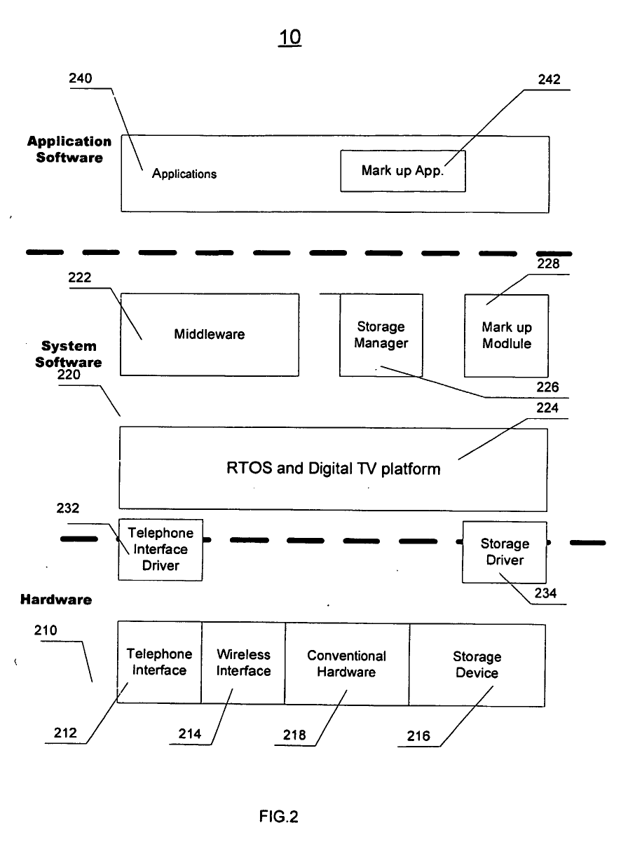

FIG. 2 is a more detailed diagram of terminal 10 showing an implementation of the present invention. In FIG. 2, terminal 10 includes three major components: hardware 210, system software 220 and application software 240. Hardware 210 includes a telephone interface 212 for connecting to telephone 30, a wireless interface for connecting to mobile device 40, a storage device 216 (e.g., a hard disk) for storing video signals and other data, and conventional hardware 218. System software 220 includes middleware 222, real-time operating system (RTOS) and digital TV platform 224, a storage manager 226 for managing storage device 216, and a mark-up module 228 for detecting on-line connection of telephone 30 or mobile device 40 and recording the date, time and channel number being viewed whenever on-line connection is established. The recorded date and time of the call and the channel number will be stored in storage device 216 for later retrieval. Application software 240 includes mark-up application software 242 for interacting with the user, e.g., prompting the user for input and receiving the user's commands for performing specific functions.

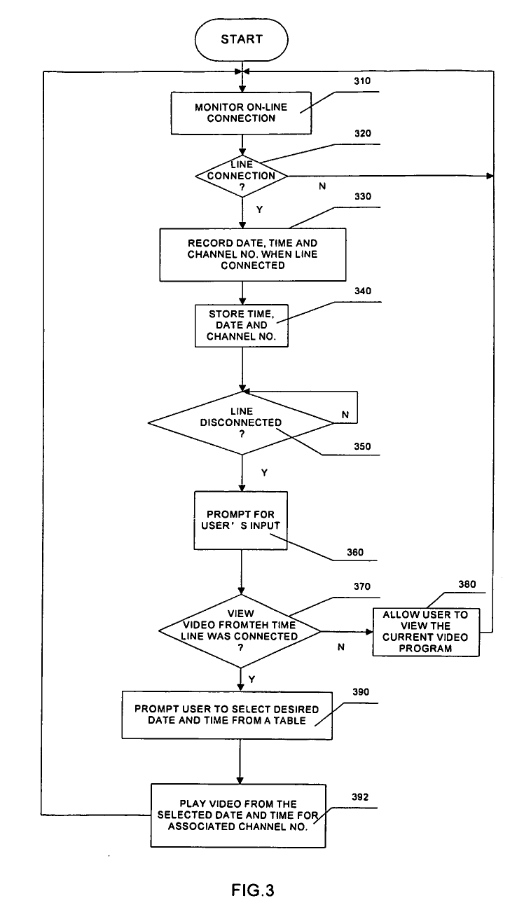

FIG. 3 shows a flow chart diagram illustrating the operation of set top terminal 10 according to one embodiment of the invention. In this operation, terminal 10 monitors on-line connection and records the date and time of an incoming or outgoing communication event such as a phone call, as well as the current channel number of TV set 20 being viewed. By keeping track of such date, time and channel number, it can provide a user with an option to continue viewing the current video program or view it from the time when the on-line connection was established. The invention provides more flexibility to the user when multiple communication events occur at different times.

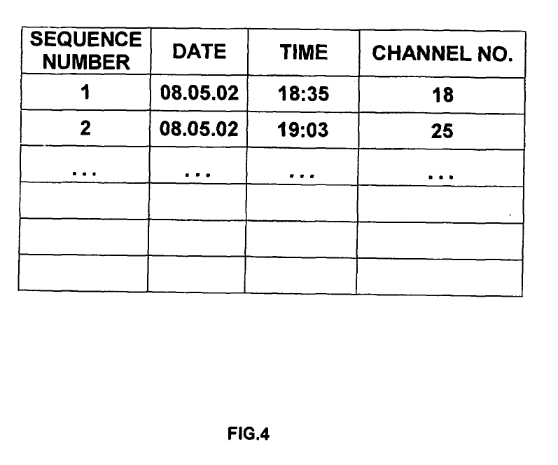

As shown in FIG. 3, at step 310, terminal 10 monitors on-line connection of either an incoming or an outgoing phone call originated from telephone 30 and mobile device 40. Upon detecting the on-line connection at step 320 as the user picks up the phone, terminal 10 records the date and time when the on-line connection is established and the current channel number being viewed (step 330). The set of data (i.e., date, time and current channel number) is stored in storage device 216, e.g., a hard disk, in a table format at step 340. A sequence number is assigned to each set of data with reference to each communication event for easy use at a later time, as will be further described in connection with FIG. 4.

Upon detecting on-line disconnection (step 350) as the user hangs up the phone, terminal 10 prompts for user's input (step 360) and provides the user with an option of whether to view the video program starting from the time on-line connection was established. If the user wants to continue viewing the current program because, for example, it is a live broadcasting event, such as a football game, terminal 10 will allow the user to view the current video program (step 380). On the other hand, if the user wants to view the missed portions of the video program because it is a drama or a TV series, for example, terminal 10 will prompt the user to select from a table a desired date and time when the on-line connection was established (step 390). If no input is detected, the channel information in the last set of data is automatically used for retrieving the recorded video program. The video program is played starting from selected date and time for the associated channel number (step 394).

By tracking the date and time whenever on-line connection is established for a communication event, the invention gives a user much greater flexibility, especially when multiple incoming/outgoing communication events occur at different times. The user merely needs to select the date and time, and the associated channel number is retrieved and used to start playing the video program from the selected date and time.

FIG. 4 shows an exemplary table format for organizing the date, time and associated channel number to be stored in storage device 216 when on-line connection of an incoming or outgoing communication event is established. In this table, a sequence number is assigned for each on-line connection and is associated with a set of data consisting of the date, time and channel number. This allows the user to easily keep track multiple incoming/outgoing communication events.

In the above description, phone calls have been used as an example of incoming/outgoing communication events. The invention can also be used in connection with other types of communication events, such as e-mails, pagers, SMS (Short Message Service), etc. Further, although the set top terminal of the invention is illustrated as a separate component, it may be integrated into the TV set.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A set top terminal, comprising:
a storage device that is configured to continuously record a current video program;
a detection circuit that is configured to detect on-line connection of a communication event;
a recording circuit, operably coupled to the storage device and the detection circuit, that is configured to record date and time of the on-line connection and a current channel number being viewed; and
a selection circuit, operably coupled to the detection circuit, that is configured to allow a user to choose between continuing viewing the video program as it is currently being played and viewing the video program from the time the on-line connection was established.

2. The terminal of claim 1, further comprising a retrieving circuit, operably coupled to the storage device and the selection circuit, that is configured to retrieve video contents from the storage device starting from the recorded date and time selected by the user, if the user chooses to view the video program from the time the on-line connection was established.

3. The terminal of claim 2, further comprising a playing circuit, operably coupled to the retrieving circuit, that is configured to play the retrieved video contents.

4. The terminal of claim 2, wherein
the selection circuit includes a prompting circuit that is configured to prompt for a user's input to select desired date and time for playing the video program; and
the retrieving circuit retrieves the video contents for a channel number associated with the selected date and time.

5. The terminal of claim 4, further comprising a playing circuit, operably coupled to the retrieving circuit, that is configured to play the retrieved video contents.

6. The terminal of claim 1, wherein the storage device stores the date, time and a current channel number being viewed in a pre-defined table format as a set of data associated with the on-line connection of the communication event, along with a sequence number for each set of data.

7. A method for tracking the time of on-line connection of a communication event in a system that continuously records a current video program in a storage device, the method comprising the steps of:
detecting whether on-line connection of a communication event is established;
upon detecting the on-line connection, recording date and time of the on-line connection and a current channel number being viewed; and
allowing a user to choose between continuing viewing the video program as it is currently being played and viewing the video program from the time on-line connection was established.

8. The method of claim 7, further comprising the step of:
if the user chooses to view the video program from the time on-line connection was established, retrieving the video contents from the storage device starting from the recorded date and time selected by the user.

9. The method of claim 8, further comprising the step of playing the retrieved video contents.

10. The method of claim 8, further comprising the step of:
after the recording step, prompting for a user's input to select desired date and time for playing the video program; and
wherein the video contents are retrieved for a channel number associated with the selected date and time.

11. The method of claim 10, further comprising the step of playing the retrieved video contents.

12. The method of claim 7, further comprising the step of storing the date, time and a current channel number being viewed in a pre-defined table format as a set of data associated with the on-line connection of the communication event, along with a sequence number to each set of data.

13. A television (TV) set, comprising:
a tuner;
a display operably coupled to the tuner; and
a recording device, operably coupled to the tuner, that includes
a storage device that is configured to continuously record a current video program,
a detection circuit that is configured to detect on-line connection of a communication event,
a recording circuit, operably coupled to the storage device and the detection circuit, that is configured to record date and time of the on-line connection and a current channel number being viewed, and
a selection circuit, operably coupled to the detection circuit, that is configured to allow a user to choose between continuing viewing the video program as it is currently being played and viewing the video program from the time the on-line connection was established.

14. The TV set of claim 13, wherein the recording device further includes a retrieving circuit, operably coupled to the storage device and the selection circuit, that is configured to retrieve video contents from the storage device starting from the recorded date and time selected by the user, if the user chooses to view the video program from the time the on-line connection was established.

15. The TV set of claim 14, wherein the recording device further includes a playing circuit, operably coupled to the retrieving circuit, that is configured to play the retrieved video contents.

16. The TV set of claim 14, wherein
the selection circuit includes a prompting circuit that is configured to prompt for a user's input to select desired date and time for playing the video program; and
the retrieving circuit retrieves the video contents for a channel number associated with the selected date and time.

17. The TV set of claim 16, wherein the terminal further includes a playing circuit, operably coupled to the retrieving circuit, that is configured to play the retrieved video contents.

18. The TV set of claim 13, wherein the storage device stores the date, time and a current channel number being viewed in a pre-defined table format as a set of data associated with the on-line connection of the communication event, along with a sequence number for each set of data.
